(19) United States
(12) Patent Application Publication
(10) Pub. No.: US 2018/0013592 A1
(43) Pub. Date: Jan. 11, 2018

(54) CHANNEL ESTIMATION USING COMPOSITE SUBCARRIERS AND COMBINED PILOTS

(71) Applicant: ZTE Canada Inc., Toronto (CA)

(72) Inventors: Yiwen Liu, Waterloo (CA); Dayong Chen, Kitchener (CA)

(21) Appl. No.: 15/545,305

(22) PCT Filed: Jan. 19, 2016
(86) PCT No.: PCT/CA2016/050040

§ 371 Date: Jul. 20, 2017

Related U.S. Application Data
(60) Provisional application No. 62/105,693, filed on Jan. 20, 2015.

(51) Int. Cl. H04L 25/02

(52) U.S. Cl. CPC H04L 25/0208; H04L 25/022; H04B 17/391; H04L 25/0222

(57) ABSTRACT

Techniques for minimum-mean-square-error (MMSE) channel estimator using channel-dependent composite subcarriers and combined pilots reduce computational complexity and memory usage while still achieving near optimum performance. A set of interpolation filters, that are pre-calculated for different radio propagation environments, e.g., channel state information, are stored in look up tables at the receiver and used to interpolate channel estimates for combined pilots to obtain channel estimates for individual subcarriers.

### CROSS REFERENCE TO RELATED APPLICATIONS

This patent document claims the benefit of U.S. Provisional Patent Application No. 62/105,693, filed on Jan. 20, 2015. The entire content of the before-mentioned patent application is incorporated by reference as part of the disclosure of this application.

### TECHNICAL FIELD

The present document relates to wireless communication, and in one aspect, to signal processing performed in a wireless signal receiver.

### BACKGROUND

Recent years has seen a significant growth in wireless communication. As the number of wireless devices and applications running on the wireless devices goes up, so does the demand for data bandwidth in wireless communication networks. To meet this growing demand for high performance wireless devices and networks, complexity of next generation wireless networks and devices is expected to significantly increase over the currently deployed wireless devices.

### SUMMARY

The present document provides techniques for reducing complexity of channel estimation at a wireless communication receiver. Channel estimation is performed using channel-dependent composite subcarriers and combined pilots to reduce computational complexity and memory usage while still achieving near optimum performance.

In one exemplary aspect, a method of designing composite subcarriers and combined pilots based on different combinations of delay spread and Doppler frequency values, pre-calculating a plurality of MMSE channel estimation matrices (one for each combination of delay spread, maximum Doppler frequency and SNR), storing the pre-calculated matrices along with the corresponding composite subcarriers and combined pilots in look-up-tables (LUTs), estimating delay spread, Doppler frequency and SNR in real-time, switching to the most appropriate LUT based on estimation results, estimating channel frequency responses (CFRs) or channel gains for composite subcarriers by interpolating the combined pilots, and finally deriving channel gains for individual subcarriers from the channel gains of the composite subcarriers.

In another exemplary aspect, a wireless communication receiver including the channel estimator using the above channel estimation method is disclosed. The channel estimator includes look-up-tables (LUTs) containing pre-calculated interpolation matrices as well as the information about the composite subcarriers and combined pilots, a least-square (LS) channel estimator, a channel state information (CSI) estimator to estimate current CSI parameters, a pilot combiner, a control unit, an MMSE channel interpolator which uses the selected LUT to perform real-time MMSE interpolation at composite subcarrier level, and a channel estimation demapper which derives the subcarrier level channel estimates from the composite level channel estimates

These, and other, aspects are disclosed in the present document.

### BRIEF DESCRIPTION OF THE DRAWINGS

FIG. 1A shows an example wireless communication system.

FIG. 1B shows an exemplary wireless Orthogonal Frequency Division Multiplexing (OFDM) receiver.

FIG. 2 shows an example of 2D channel interpolation.

FIG. 3 shows examples of composite subcarrier.

FIG. 4 shows an example flowchart of a method of interpolation matrix pre-calculation.

FIG. 5 shows example steps of channel estimation using composite subcarriers and combined pilots.

FIG. 6 show an example of a channel estimation apparatus.

FIG. 7 shows an example application of a 2D MMSE channel estimation to Long Term Evolution (LTE) User-equipment Reference Signal (UE-RS) based transmission.

FIG. 8 shows an example comparison of computational complexity and memory usage using conventional and disclosed method.

FIG. 9 shows an example of additional memory saving utilizing symmetry.

FIG. 10 shows an example method of estimating a channel in wireless communication.

FIG. 11 shows an example block diagram of a minimum mean square error (MMSE) channel filter coefficient generator apparatus.

FIG. 12 shows an example block diagram of a channel estimation apparatus for use in a receiver of an orthogonal frequency division multiplexing (OFDM) signal.

### DETAILED DESCRIPTION

In recent years, the combination of Multi-Input Multi-Output (MIMO) and OFDM technologies has made high data rate wireless links up to 1 Gbps a reality, and the trend of achieving even higher data throughput is continuing. For example, the 3GPP Release-10 LTE-Advanced increases the downlink peak data rate 10 times, as compared to Release 8 LTE, by aggregating up to 5 20-MHz component carriers and by increasing the maximum number of transmission layers N_{D} from 4 to 8. The carrier aggregation increases the number of subcarriers from 1000 to 5000, while the enhanced downlink MIMO increases the maximum number of channel paths N_{RX}×N_{D} from 4×4=16 to 8×8=64, where N_{RX} is the number of receive antennas. These two features greatly increase the complexity of modem algorithm design, particularly for the modem chips used for the user equipment (UEs) and for the channel estimation module to the largest extents. Since MIMO detection is performed subcarrier by subcarrier after estimating the channel matrix which includes N_{RX}×N_{D} gains for each subcarrier, the maximum number of channel gains that need to be estimated per transmission-time-interval (TTI) is increased from 4×4×1000 to 8×8×5000, a twenty-times increase compared to LTE.

The challenge in channel estimation algorithm design is further caused by the reduced pilot overhead in LTE-Advanced. An LTE/LTE-A system supports two types of pilots that can be used for data demodulation: (a) common reference signal (CRS) is transmitted over the whole system bandwidth and (b) UE specific reference signal (UE-RS) is transmitted only in the resource blocks (RBs) currently allocated to a specific UE, where an RB includes 12 subcarriers in frequency and two time slots in time with each slot consisting of 7 OFDM symbols if normal length cyclic prefix (CP) is used. To be backward compatible with the Release 8/9 LTE standard, the UE-RS pattern is not to collide with existing signal such as CRS. To minimize pilot overhead, Code-Division-Multiplexing (CDM) is used which means the UE-RS pattern is sub-optimum from the channel estimation perspective. Furthermore, the pilot density is lower when compared to CRS. It is well known that channel estimation performance is very sensitive to pilot density and pattern. Given the lower density and sub-optimal UE-RS pattern, a high quality channel estimator must use advanced algorithm to achieve satisfactory performance, otherwise using less advanced algorithm can cause drastic performance degradation. However, advanced algorithms incur high computational complexity which conflicts the requirement for reducing complexity given the greatly increased processing load in channel estimator.

The channel estimation problem in an OFDM system can be posed as a two dimensional (2D) sampling problem. To facilitate channel estimation, the transmitter multiplexes known modulation symbols into the transmitted frequency-time grid to enable the channel estimator to make observations at the pilot locations. As long as the pilot spacing satisfies the Nyquist theorem in both frequency and time domain, i.e. at least 2× over-sampling, the receiver can resolve the channel variations by interpolating the channel observations in order to estimate channels at data locations and also improve the initial channel estimation at the pilot locations.

Some channel estimation algorithms are based on 2D minimum-means-square-error (2D MMSE) interpolation which has much better performance than for example a maximum likelihood (ML) algorithm because the 2D MMSE algorithm can incorporate frequency and time correlation of the radio channel into the estimation process. One possible drawback of the MMSE, especially the 2D MMSE algorithm, is its very high computational complexity and high memory usage. Thanks to research efforts aimed at reducing the complexity while still achieving near optimum performance, the MMSE algorithm has been greatly simplified. One aspect of the disclosed technology with reduced complexity is to pre-compute the MMSE interpolation matrix using predefined values of channel state information (CSI) parameters, including delay spread (either maximum delay spread or root-mean-square, or RMS, delay spread), maximum Doppler frequency, and signal to noise ratio (SNR). To accommodate different radio propagation environments, multiple interpolation matrices are pre-calculated, one for each different combination of the CSI parameters, and saved in look-up-tables (LUTs). During the real-time operation, the channel estimator measures the current CSI values, switches to a more appropriate LUT depending on the measured CSI values, and uses pre-stored interpolation matrix to perform MMSE channel interpolation.

However, the above LUT-driven method may still require too much computational power and memory space, especially for 2D MMSE channel estimation.

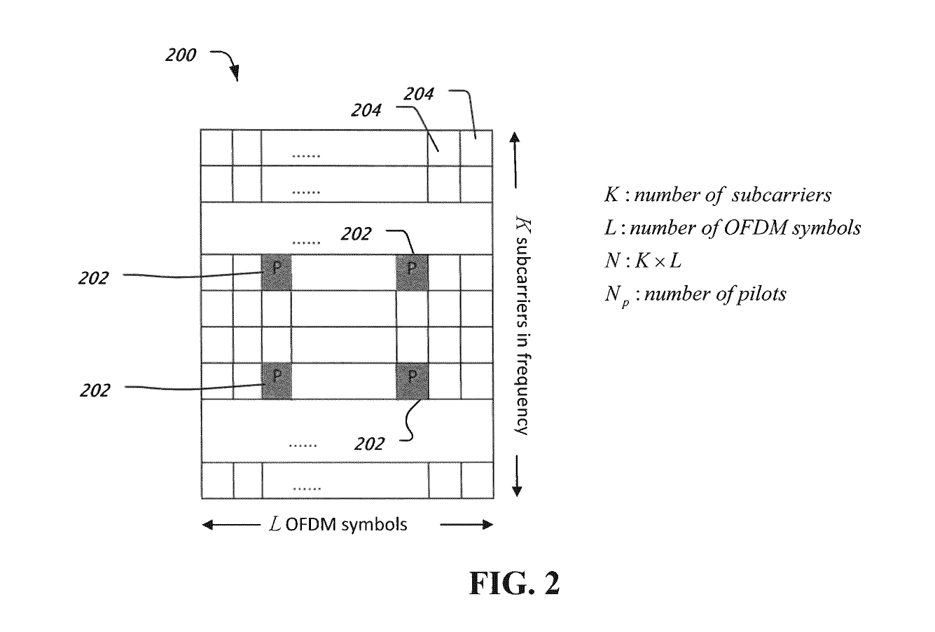

FIG. 2 shows an example of a 2D resource grid 200 for performing a 2D channel interpolation. The receiver grid 20 consists of N=K×L subcarriers, where K is the number of subcarriers in frequency (in the vertical direction along grid 200) and L is the number of OFDM symbols (in the horizontal direction). Nₚ is the number of pilots, e.g., pilots 202 multiplexed into the resource grid 200. To estimate each channel gain at a single subcarrier 204, a straightforward method would require Nₚ multiplications and Nₚ−1 additions. In addition, to estimate channel for each subcarrier, Nₚ interpolation filter coefficients need to be stored since the distances of different subcarriers to the pilots to be interpolated are in general different. The memory usage is further increased multiple times if several interpolation matrices need to be stored in LUTs to cover different channel radio environments.

Some techniques disclosed in the present document can be used to reduce the complexity and memory requirements by using composite subcarriers and/or combined pilots, which may be composited or combined based on estimated channel characteristics. As one example, a composite subcarrier may include multiple contiguously neighboring subcarriers, and a combined pilot consists of several closely located pilots. The number of subcarriers that make up a composite subcarrier and the geometrical shape of a composite subcarrier in a 2D resource grid may depend on radio environment at the run time based on parameters such as the delay spread and Doppler frequency values. In another aspect, multiple individual pilots may be combined (for calculations) to form a combined pilot. The number of individual pilots making up a combined pilot may also be dependent on radio environment such as the delay spread and Doppler frequency and the pilot pattern, e.g., placement of pilot signals in the resource grid. In some embodiments, the channel estimates at the combined pilots are interpolated to get channel estimates at composite subcarriers. Since each composite subcarrier consists of multiple subcarriers and each combined pilots consists of multiple pilots, both computational complexity and memory usage are greatly reduced. Furthermore, since the channel gains at individual subcarriers comprising a composite subcarrier are highly correlated, and channel gains at individual pilots are highly coherent, near MMSE performance can be achieved.

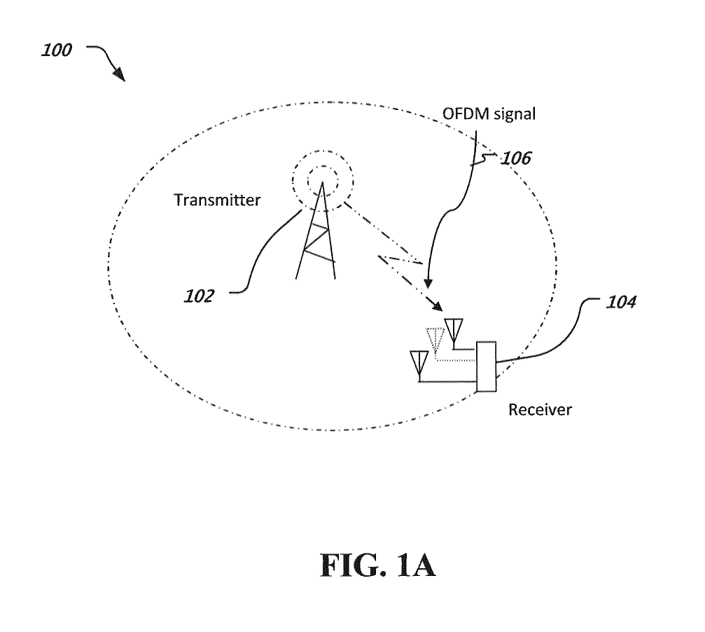

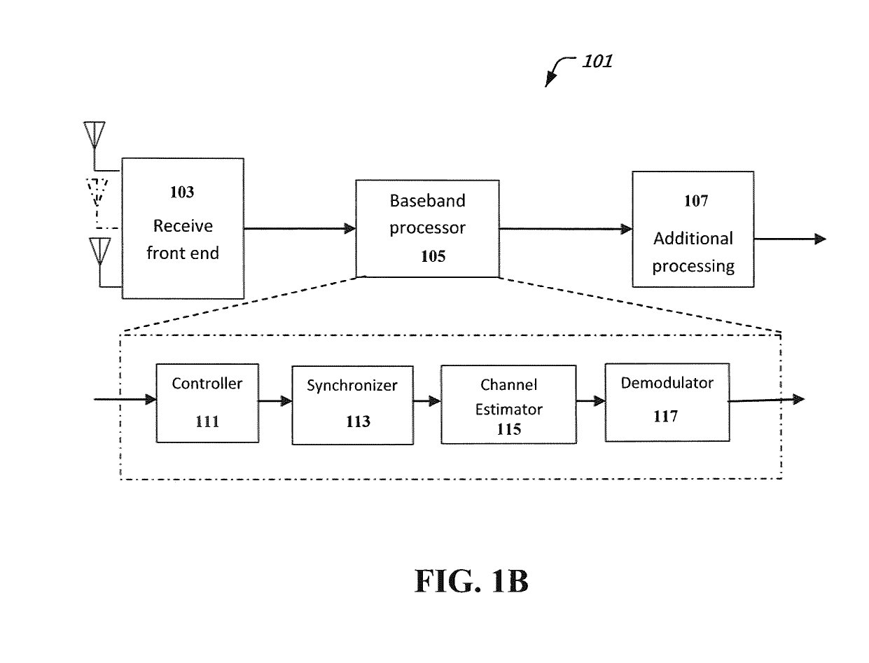

FIG. 1A shows an example wireless communication system 100 in which a transmitter 102, e.g., a cell tower or a base station, communicates with a receiver 104, e.g., a device equipped with a wireless interface, over a channel 106 using an OFDM signal transmission. The transmitter 102 typically also includes a reception mechanism by which the base station receives signal transmissions from the receiver 104. The presently disclosed techniques can be implemented at the receiver 104 or at the reception mechanism of the transmitter 102.

FIG. 1B illustrates an exemplary wireless MIMO receiver 101 in which the techniques described in the present document can be implemented. The receiver 101 includes a frontend 103, a baseband processor 105 and a module that represents additional processing of the demodulated signal (107). The frontend 103 down-converts each of the N_{RX} received signals to baseband, removes CP from each block of samples comprising an OFDM symbol, and performs Fast Fourier Transform (FFT) to convert the received signal to frequency domain. The baseband processor 105 may include a controller 111, a synchronizer 113, a channel estimator 115 and a MIMO demodulator 117.

In some embodiments, the controller 111 de-maps the received signals to different physical channels and physical signals and controls the overall processing of the baseband processor 105. In some embodiments, the synchronizer 113 performs time-frequency synchronization of the receiver 101 which is used to establish and maintain orthogonality of the received subcarriers. In some embodiments, the channel estimator 115 picks up received pilots, estimates channel matrix for each subcarrier, and the noise variance \hat{δ}² and, if interference rejection combining is supported, the impairment covariance matrix \hat{R} where impairment includes both interference and thermal noise. The demodulator 117 uses the received signals, estimated channel matrices, noise variance or impairment covariance matrix provided by the channel estimator 115 to detect the transmit symbols and calculate the log-likelihood ratios (LLRs) for each bit of in the detected symbols. The LLRs are forwarded to the Viterbi and Turbo decoder, which is part of the additional processing module 107 for error correction decoding. In some embodiments, some or all of the above functions described with respect to 111, 113, 115 and 117 may be implemented using partial or full hardware assistance.

In an OFDM system, the received baseband signal at a subcarrier location is given by

r(k,l)=h(k,l)s(k,l)+n′(k,l) Eq. 1

where 0≦k≦K−1 and 0≦l≦L−1 are frequency/time indices of the subcarriers, r(k,l) is the received signal, h(k,l) is the channel frequency response (CFR) or channel gain, n′(k,l) is additive noise and N=K·L is the transmission block size with K subcarriers in frequency and L OFDM symbols in time. In a Single-In-Single-Out (SISO) OFDM system, the receiver typically estimates one channel coefficient h(k,l) per subcarrier.

In a Multiple-Input-Multiple-Output (MIMO) OFDM system, r(k,l) is replaced by an N_{RX}×1 vector, h(k,l) is replaced by an N_{RX}×N_{D} matrix and n′(k,l) is replaced by a N_{RX}×1 vector, and the receiver needs to estimate N_{RX}×N_{D} channel gains per subcarrier.

In OFDM based communication systems, to aid channel estimation at the receiver 101, known pilot symbols sₚ(k,l) are transmitted together with data and control symbols where (k,l)ε P and P is the set of pilot locations, e.g., as depicted in resource grid 200. For the received pilot signals, multiplying both sides of EQU.1 and using the property sₚ(k,l)s*ₚ(k,l)=1 leads to the least-square (LS) channel estimates \tilde{h}(k,l) at the pilot locations:

\tilde{h}(k,l)=r(k,l)s*ₚ=h(k,l)s(k,l)s*ₚ(k,l)+n(k,l)s*ₚ(k,l)=h(k,l)+n(k,l) Eq. 2

where h(k,l) and n(k,l) represent true channel gain and channel noise, respectively. In implementations, the LS channel estimates are too noisy and cannot be used for demodulation purpose. In addition, the LS channel estimates are available only at pilot locations, but unknown at data subcarrier locations. The subsequent interpolation process suppresses noise and interpolating/predicting the LS channel estimates to get refined channel estimates at all subcarriers.

Consider h(k,l) as a wide-sense stationary 2D stochastic process, the correlation between the channels at two subcarriers (k₁,l₁) and (k₂,l₂) depends only on the distance between the two subcarriers in frequency and time and therefore the 2D correlation function of the mobile radio channel can be written as:

r_{ft}=E{h(f+Δf,t+Δt)h*(f,t)}=r_{ft}(Δf,Δt)=r_{ft}((k₁−k₂)ΔF,(l₁−l₂)Tₛ) Eq. 3

where ΔF is subcarrier bandwidth and Tₛ is OFDM symbol duration.

The 2D correlation function can be decomposed into the product of a frequency correlation function r_{f}(Δf) and a time correlation function rₜ(Δt), which can significantly simplify channel estimation:

r_{ft}((k₁−k₂)ΔF,(l₁−l₂)Tₛ)=r_{f}{(k₁−k₂)ΔF}rₜ{(l₁−l₂)Tₛ} Eq. 4

The correlation functions, rₜ(Δt) and r_{f}(Δf), are dependent on radio environment at the time of operation, e.g., the radio propagation channel model, delay spread and Doppler frequency. Consider a uniform power delay profile (PDP) with maximum delay spread τₘₐₓ and a uniform Doppler power spectrum with maximum Doppler frequency fₘₐₓ, the correlation functions are given by:

r_{f}((k₁−k₂)ΔF)=sinc(τₘₐₓΔF(k₁−k₂)) Eq. 5A

rₜ((l₁−l₂)Tₛ)=sinc(fₘₐₓTₛ(l₁−l₂)) Eq. 5B

Alternatively, if a channel model with exponentially decaying PDP is used, the frequency correlation function is given by:

$${r}_{f} ( ( {k}_{1} - {k}_{2} ) Δ F ) = \frac{1}{1 + j 2 {πτ}_{max} Δ F ( {k}_{1} - {k}_{2} )} \qquad Eq . 6$$

An alternative time correlation function is given by zero-th order Bessel function of first kind

rₜ((l₁−l₂)Tₛ)=J₀(2πfₘₐₓTₛ(l₁−l₂)) Eq. 7

Interpolation means to represent channel estimation ĥ(k,l) as a linear combination of LS channel estimates \tilde{h}(k′,l′) at Nₚ pilots where (k′,l′) correspond to pilot locations.

$$\hat{h} ( k , l ) = {\sum }_{( {k}^{′} {l}^{′} )} ω ( k , l , {k}^{′} , {l}^{′} ) \tilde{h} ( {k}^{′} , {l}^{′} ) \qquad Eq . 8$$

The interpolation process is also a filtering process, and values of the filter taps ω(k,l,k′,l′) determine filter characteristics such as filter bandwidth. Furthermore, interpolation has two effects: due to averaging or lowpass filtering, it suppresses noise, but at the same time may introduce bias. The capability of noise suppression can be measured by a processing gain. Out of all Nₚ-tap filters, the averaging filter (filter with all taps being equal to 1/Nₚ) achieves the largest processing gain of Nₚ. Interpolation may introduce bias because the channels at different pilot locations are in general different. The optimum channel interpolation filter is based on the minimum-mean-squared-error (MMSE) criterion by choosing filter taps ω=[θ₀, ω₁, . . . ω_{N}_{ₚ}₋₁]^{T} to minimize the mean-squared-error (MSE) between h(k,l) and ĥ(k,l).

$${ω}_{MMSE} ( k , l ) = {argmin}_{ω} E \{ {\vert h ( k , l ) - \hat{h} ( k , l ) \vert}^{2} \} \qquad Eq . 9$$

The MMSE interpolation can be performed in one dimension (e.g., in frequency domain) which can be called 1D MMSE interpolation, or in two-dimension in both frequency and time domain at the same time which can be called 2D MMSE interpolation. Since the 2D interpolator can fully utilize all neighboring pilots, its performance can be superior to that of 1D interpolator. The performance of 2D-MMSE interpolation can be approximated by cascading two 1D interpolators, e.g. first interpolation in frequency and then in time direction, which is called 2×1D MMSE interpolation, provided that there are enough pilots in both directions. If there are not a sufficient number of pilots in time or frequency or both directions, then using 2D MMSE typically achieves a significantly better performance than using 2×1D MMSE interpolator.

For a 2D MMSE interpolator, let H=[h(0,0), . . . h(0,L−1), . . . h(K−1,0), . . . h(K−1,L−1)]^{T} denote the N×1 vector, where N=K*L, containing true channels for all individual subcarriers. Let Ĥ=[ĥ(0,0), . . . ĥ(0,L−1), . . . ĥ(K−1,0), . . . ĥ(K−1,L−1)]^{T} denote the N×1 vector with estimated channels and denote the Nₚ×1 vector of LS channel estimates at Nₚ pilots as \tilde{H}=[\tilde{h}(k₀,l₀),\tilde{h}(k₁,l₁), . . . ,\tilde{h}(k_{N}_{ₚ}₋₁,l_{N}_{ₚ}₋₁)]^{T} where Nₚ denote the total number of pilots. With the above notation, the 2D-MMSE channel estimate Ĥ is given by:

$$\begin{matrix}\hat{H} = [ {{R}_{H \tilde{H}} ( {R}_{HH} + \frac{1}{SNR} )}^{- 1} ] \tilde{H} & Eq . 10 A \\ {R}_{H \tilde{H}} = E \{ \tilde{H} {H}^{H} \} , {R}_{HH} = E \{ {HH}^{H} \} & Eq . 10 B\end{matrix}$$

where R_{H\tilde{H}} is the cross-covariance matrix between H and \tilde{H}, R_{H\tilde{H}} is the auto-covariance matrix of H and the expression in the square brackets is the N×Nₚ 2D-MMSE interpolation matrix W. Each row of W corresponds to the MMSE filter taps for a particular subcarrier, which corresponds to EQU.9. EQU.10 shows that the interpolation matrix depends on two correlation matrices and SNR, and the correlation matrices in turn depend on the frequency and time correlation function defined in EQU.5A.

The complexity of the MMSE channel estimation would be significantly higher if the interpolation matrix W were calculated in real-time. Fortunately, the matrix W can be pre-calculated by assuming specific values for the radio environment in which the interpolation matrix is to be used. For example, three CSI parameters: delay spread, Doppler frequency and SNR could be used (one or more at a time) to determine which interpolation matrix to use. The pre-calculated matrix W can be stored in an LUT and used for real-time interpolation many times until there are significant changes in channel correlation function and/or SNR. The channel correlation functions remain the same as long as the radio propagation environment doesn't change significantly. To cover different radio propagation environments, multiple interpolation matrices corresponding to different CSI parameter values can be pre-calculated and stored in multiple LUTs. By switching to the most appropriate LUT based on estimated channel parameter values, near MMSE performance can be achieved in practice.

The reason why it is advantageous to pre-calculate the interpolation matrix corresponding to a specific delay spread and Doppler frequency and then used for demodulating many packets without significant performance loss can be attributed to the following. (1) The channel correlation statistics typically doesn't change significantly if the radio propagation environment remains the same; and (2) even if the channel propagation changes, for example, the delay spread and/or Doppler frequency change, as long as the actual Doppler frequency is less than the Doppler frequency the pre-calculated matrix is designed for, there is little degradation compared with when the actual Doppler frequency exactly matches its design value.

As disclosed herein, even with LUT-driven MMSE interpolation, the complexity could still be high due to large number of channel gains that need to be estimated and could further be reduced. In addition, the conventional LUT-driven MMSE interpolator consumes large memory space. Since multiple interpolation LUTs are needed to cover different radio propagation environments, a total of Q·N·Nₚ words of coefficients need to be stored assuming Q LUTs and each containing N·Nₚ coefficients.

In practice, channel gains at adjacent subcarriers are typically highly correlated. For example, in LTE/LTE-A standard, the subcarrier bandwidth ΔF is 15 kHz and OFDM symbol duration Tₛ=71.4 μs, two frequency-adjacent subcarriers have a frequency correlation of 0.9996 and a time correlation of 0.9999. Another way of measuring frequency correlation is to use coherence bandwidth; for the 3GPP Extended Pedestrian A (EPA) channel model with an RMS delay spread of 0.04 3 μs, the 90% coherence bandwidth

$${B}_{c , 90 \%} = \frac{1}{50 {τ}_{rms}} = 465 KHz .$$

Since each subcarrier has a bandwidth of 15 KHz, the coherence bandwidth covers 31 subcarriers so that channels at 31 consecutive subcarriers have a correlation of 90% or higher. Similarly, the coherence bandwidth for Extended Vehicular A model (EVA) channel covers more than 3 consecutive subcarriers. With regard to time correlation, for the EVA5 channel with a maximum Doppler frequency of 5 Hz, the coherence time is

$${T}_{c} = \frac{1}{2 {f}_{max}} = \frac{1}{2 \times 5} = 0.1 ms$$

which means that channel is highly correlated in many consecutive OFDM symbols. A typical radio propagation environment is determined by, among other parameters, the combination of delay spread and Doppler frequency. For example, one environment type may correspond to a small delay spread and high Doppler, another environment type may correspond to a large delay spread and a low Doppler, and another environment type may correspond to a medium delay spread and a medium Doppler, etc. In the first case, the channels for at least 2 consecutive subcarriers within the same OFDM symbol can be considered as identical. For the second case, the channels for at least two consecutive OFDM symbols can be considered as identical. In general, a cluster of contiguous subcarriers can be considered to have the same channel gain. The number of different combinations and thresholds used to categorize delay spread and Doppler frequency depend on the performance-complexity trade-off; using finer thresholds and more combinations than low, medium and high described above can improve performance, but also increase complexity and memory usage.

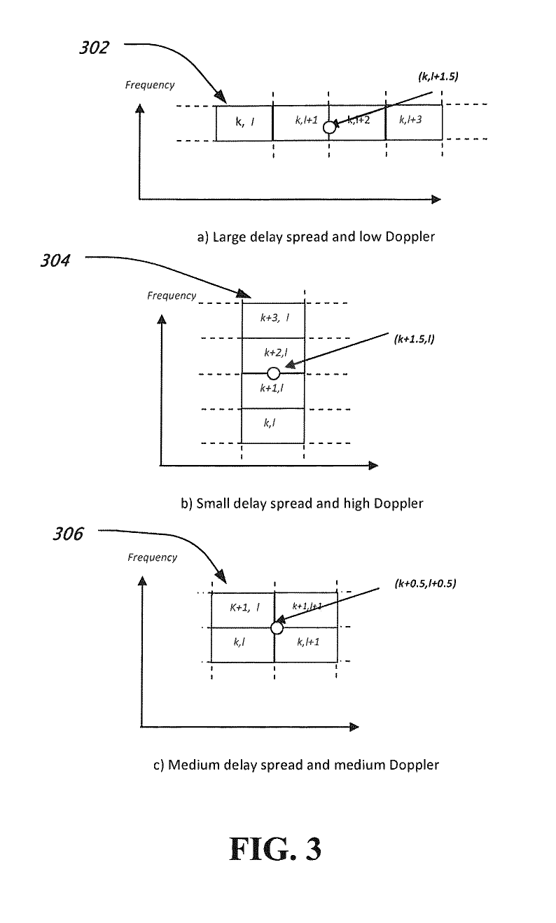

FIG. 3 illustrates three examples in which the design of composite subcarriers is based on the values of delay spread and maximum Doppler frequency. A composite subcarrier may include two or more contiguous subcarriers, e.g., neighboring subcarriers in the frequency domain. If the RMS delay spread τᵣₘₛ is large (e.g., above a pre-determined threshold), but the maximum Doppler frequency fₘₐₓ is very small, the shape of a composite subcarrier, as depicted on the time-frequency resource grid, may appear as a short and broad rectangle 302. The shape of a composite subcarrier may be a tall and thin rectangle 304 if τᵣₘₛ is very small, but fₘₐₓ is very large. A composite subcarrier can be substantially square, e.g., 306, if τᵣₘₛ and fₘₐₓ values make the corresponding mobile radio channel equally time and frequency selective. The location of a composite subcarrier could be assumed to be at the center of gravity of the composite subcarrier.

As described herein, 302 is an exemplary composite subcarrier corresponding to large τᵣₘₛ, and small fₘₐₓ with 1×4 subcarriers and centered at the location (k,l1+1.5). Similarly, 304 is an exemplary composite subcarrier corresponding to small τᵣₘₛ and large fₘₐₓ with 4×1 subcarriers and centered at (k+1.5,l). Similarly, 306 is an exemplary composite subcarrier consisting of 2×2=4 subcarriers and centered at (k+0.5,l+0.5). In general, the number of subcarriers in a composite subcarrier need not be the same.

In some embodiments, pilot signals may similarly be handled at the receiver side. For example, in one example aspect, the design of combined pilot is dependent on the values of delay spread and maximum Doppler frequency, and additionally on the pilot pattern. The pilot pattern is given by the standard being considered. For example, if two pilots are adjacent to each other, they can typically form a combined pilot.

The disclosed method includes two parts: (a) Design channel dependent composite subcarriers and combined pilots and generate associated MMSE interpolation matrix, this is performed offline and the results are loaded into the memory of the channel estimator shown in FIG. 1B, and (b) real-time MMSE channel estimation using the pre-calculated interpolation matrices.

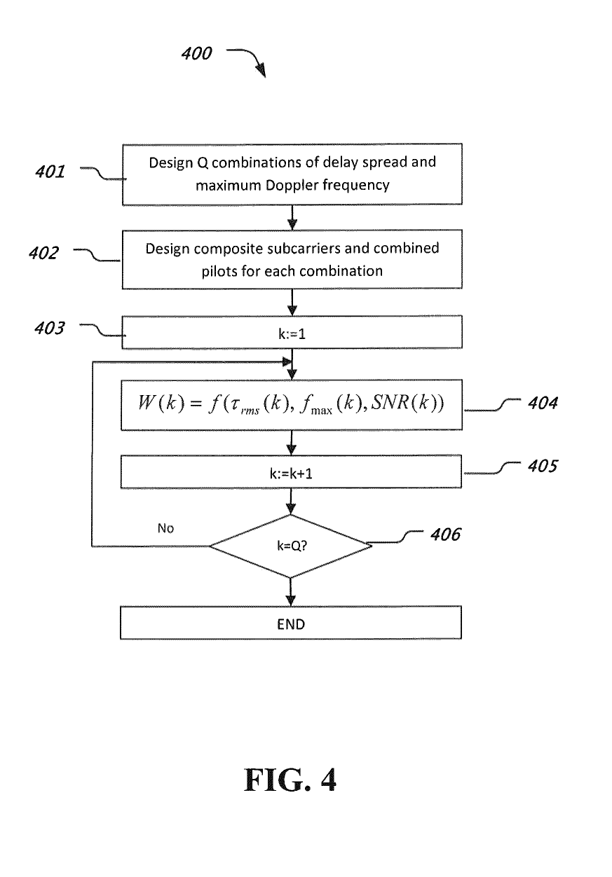

FIG. 4 includes an exemplary flowchart of a method 400 of pre-calculating MMSE channel matrices which includes:

401: Design Q combinations of delay spread and maximum Doppler frequency values.

402: Design composite subcarriers and combined pilots for each combination based on τᵣₘₛ(k) and fₘₐₓ(k) to generate the locations of composite subcarriers and combined pilots.

403: Initialize index k to 1.

404: Calculate MMSE interpolation matrix W(k) as a function of the k-th combination of the CSI parameters τᵣₘₛ(k), fₘₐₓ(k) and SNR(k) wherein the interpolation is for composite subcarriers with regard to combined pilots generated in 402.

405: Increment the value of index k by 1.

406: Stop if k is equal to Q, which is the number of different CSI combinations. Otherwise go back to 404.

The matrices pre-calculated using process 400 may be stored in a memory of a wireless receiver as LUTs that can be retrieved based on the estimated radio propagation environment, e.g., CSI parameters, or in another fashion.

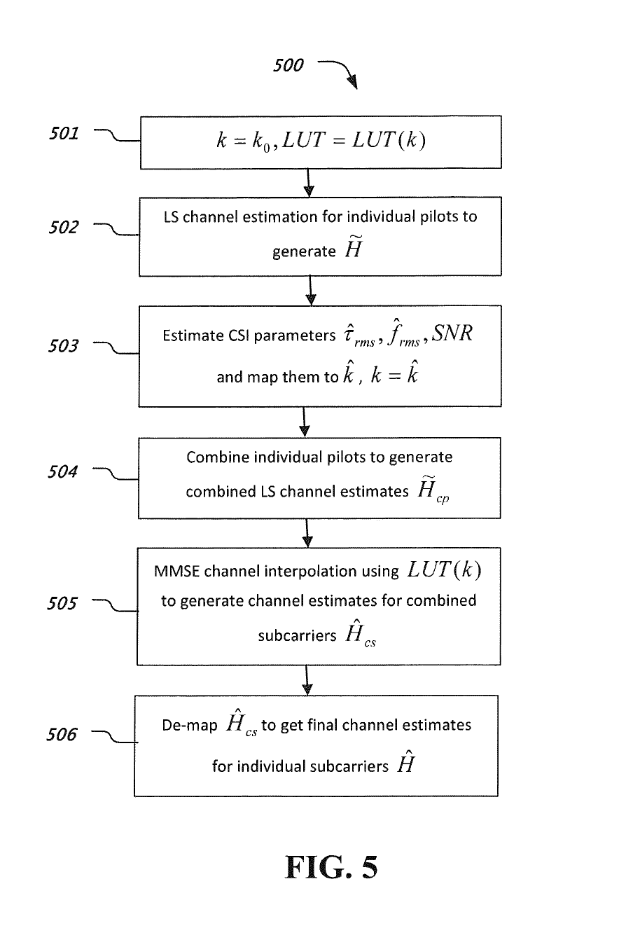

FIG. 5 shows a flowchart of an example of a real-time MMSE channel estimation process 500 which includes, for a channel estimation session, the following:

501: Load the default LUT, LUT(k₀), where k₀ is the index of the default LUT, and set index k to k₀. A default LUT can, for example, correspond to a medium delay spread and a medium Doppler frequency or be the same as the result of the last channel estimation session.

502: Compute the LS channel estimates for pilots using the received pilot signals r(k,l) and the known pilot symbol sequence sₚ(k,l) which results in the vector \tilde{H} of LS channel estimate.

503: Estimate radio propagation environment, e.g., by estimating current values of radio propagation environment parameters such as the delay spread, Doppler frequency and SNR and mapping them into an LUT index \hat{k}, depending how the estimated values compare (same, less or greater than) with regard to the pre-defined threshold values. If \hat{k} is different from the current index k, load LUT(\hat{k}), and update k with \hat{k}.

504: Combine the LS channel estimates of the pilots that belong to their respective combined pilots to generate combined LS channel estimates \tilde{H}_{cp}, using \hat{k} and as inputs.

505: Perform MMSE channel interpolation using LUT(k), \tilde{H}_{cp}, and k as inputs to generate MMSE channel estimate for composite subcarriers \tilde{H}_{cs}.

506: De-map the MMSE estimates for composite subcarriers to get final MMSE channel estimates for individual subcarriers. This may be accomplished by, for example, simply copying the channel estimate of each composite subcarrier to the channel estimates of the associated individual subcarriers, resulting in H. Alternatively or additionally, frequency/time selective weighting may be used when converting from the MMSE estimate for the composite subcarrier to individual subcarriers.

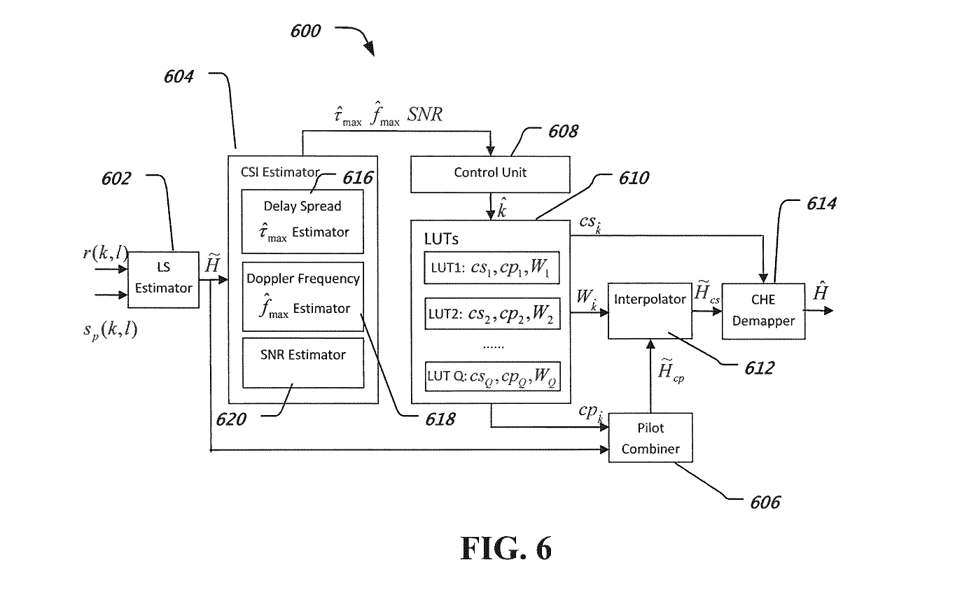

FIG. 6 illustrates an exemplary embodiment of the MMSE channel estimation apparatus 600 which comprises an LS channel estimator 602, a CSI estimator 604, a pilot combiner 606, a control unit 608, multiple look-up-tables (LUTs) corresponding to different combinations of CSI parameters 610, an MMSE interpolator 612, and a channel estimation demapper 614. Upon system reboot the LUT which corresponds to the default delay spread, maximum Doppler frequency and SNR is used as the starting point. In some embodiment, the default LUT may be a system-wide constant that, e.g., may correspond to an average or a medium delay spread and an average or medium Doppler frequency value. In some embodiments, the default LUT may be the last used LUT.

In some embodiments, the LS estimator 602 multiplies the received pilot signals with the corresponding complex-conjugates of known pilot symbols to produce LS channel estimates \tilde{H} at pilot locations which is passed to the CSI estimator 604 and pilot combiner 606 for further processing.

The CSI estimator 604 comprises modules that estimate the current radio propagation environment, e.g., a delay spread estimator 616, a Doppler estimator 618 and an SNR estimator 620. In some embodiments, using the LS channel estimates, the delay spread estimator 616 measures both maximum delay spread and RMS delays spread, the Doppler estimator 618 estimates the maximum Doppler frequency, and the SNR estimator 620 estimates the signal-to-noise-ratio. In some embodiments, a low-pass filter is used for each estimator, which is applied to the measurement CSI values to produce the final estimated CSI values which are sent to the control unit 608.

The control unit 608 processes the current CSI estimates to map the CSI estimates into an LUT index \hat{k}. If the new index is not the same as the index of the currently used LUT, the control unit reconfigures the LUT, including the pre-calculated interpolation matrix and the corresponding composite subcarriers and combined pilots, and sends the new index of the selected LUT to the interpolator 612, the pilot combiner 606 and the channel estimation demapper 614.

In some embodiments, the LUTs include Q sets of composite subcarrier information csₖ, combined pilot information cpₖ and pre-calculated interpolation matrices W(k), one set for each delay spread, maximum Doppler frequency and SNR combination. The variable csₖ indicates the mapping between individual subcarriers and composite subcarriers. The variable cpₖ indicates the mapping between individual pilots and combined pilots. In some embodiments, the matrix W(k) is passed to the channel interpolator 612 to calculate composite subcarrier level MMSE channel estimation, cpₖ is passed to the pilot combiner 606 to produce combined pilots and csₖ is passed to the channel estimation demapper 614 to generate subcarrier level MMSE channel estimates based on the composite subcarrier level MMSE channel estimates.

Based on the index of the LUT generated by the control unit 608, the pilot combiner 606 combines one or more LS channel estimates to form a combined LS channel estimate that represents the combined pilot together with its location or coordinate (k,l). The pilot combiner 606 can repeat this step to form all combined pilots. The combined LS channel estimates, which are represented by an N_{cp}×1 vector \tilde{H}_{cp}, are passed to the MMSE interpolator 612.

The interpolator 612 retrieves the MMSE filter matrix W_{\hat{k}} corresponding to the currently selected LUT and applies the matrix to the vector of coarse channel estimates \tilde{H}_{cp} to produce a vector of MMSE channel estimates for composite subcarriers Ĥ_{cs}, which is then passed to the channel estimation demapper 614. The channel estimation demapper 614 calculates the channel estimates for all subcarriers using the channel estimates at composite subcarrier level Ĥ_{cs} and the composite subcarrier information csₖ. In some embodiments, the demapper 614 copies the channel estimate of composite subcarriers to the channel estimates of all subcarriers that belong to the composite subcarrier. Other methods can also be used to derive the subcarrier level MMSE channel estimates from the composite subcarrier level channel estimates, e.g., linear interpolation between known channel estimation values.

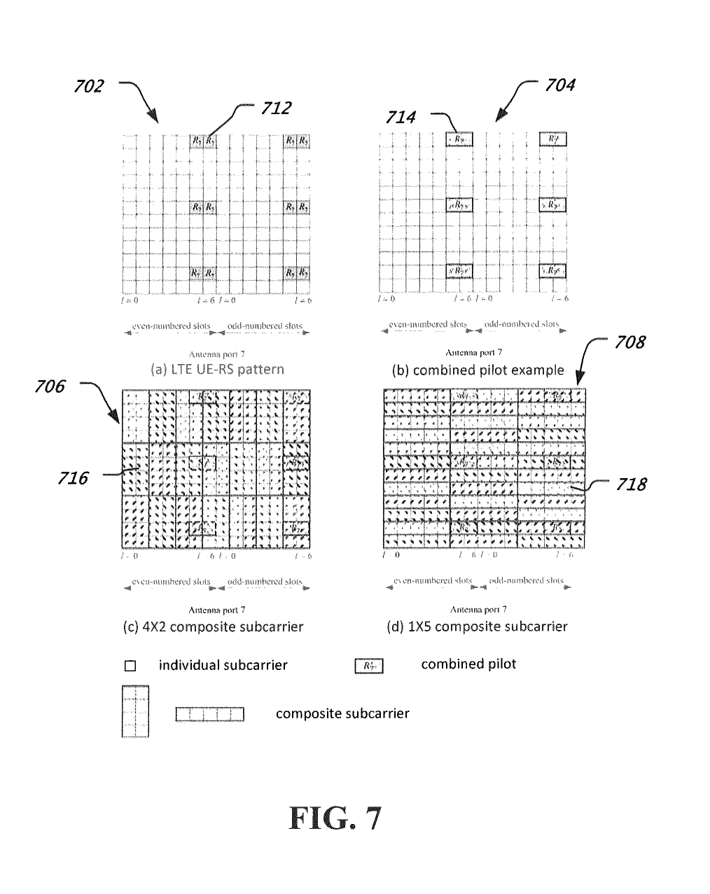

FIG. 7, resource grid 702 illustrates the UE-RS pilot pattern in the 3GPP LTE/LTE-A specification. The channel estimation for UE-RS is done for a pair of PRBs 710 (physical resource blocks) because the MIMO precoder applied to the other PRBs can be different. It can be seen from 702 that the UE-RS grid consists of 12×14=168 subcarriers and 12 pilots 712. The 6 UE-RS in each slot consists of 3 pairs of 2 consecutive UE-RSs. Since each pair of UE-RS symbols are directly adjacent to each other, they can be grouped together as a combined pilot 714 almost without distortion as shown in resource grid 704 which reduces the number of pilots, or equivalently the number of MMSE channel filter taps, from 12 to 6. The composite subcarrier 714 can be designed for different delay spread and Doppler frequency combinations. Two examples of composite subcarriers of size 4×2 (716) and 1×5 (718) are shown in resource grids 706 and 708 respectively. The 4×2 composite subcarrier 716 can be advantageously used for relatively frequency-flat and rapidly time-varying channel whereas the 1×5 composite subcarrier 718 can be advantageously used for highly frequency selective but slowly time-varying channel.

In some embodiments, the MMSE interpolation matrices can be generated only for the 12 UE-RS pilot locations 712 to improve the accuracy of interference covariance matrix estimation. The channel estimation accuracy at pilot locations is important for the performance of interference rejection combining (IRC) receivers because interference covariance matrix is calculated by averaging interference sample covariance matrices and the channel estimate accuracy at pilot locations impacts the accuracy of the interference samples. Note channel interpolation for pilot location is also called smoother since the LS channel estimates at pilot locations are generally very “rough” with high noise level.

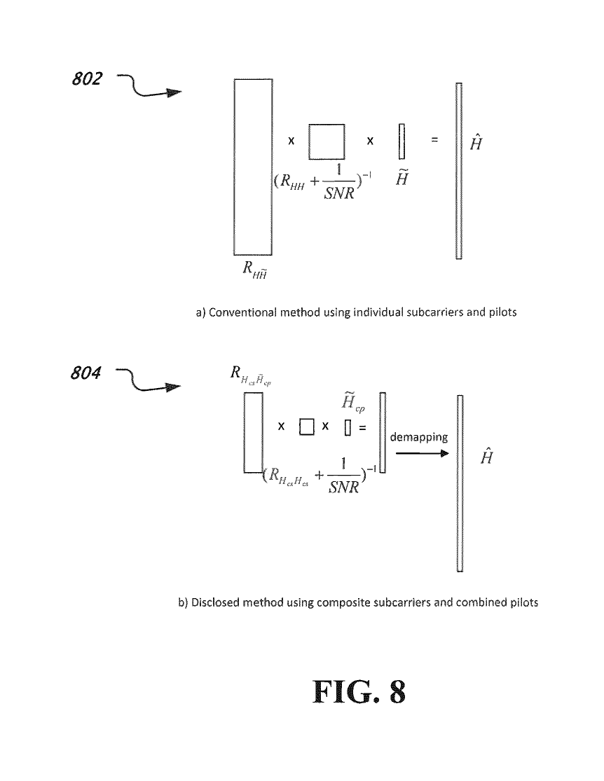

FIG. 8 illustrates an example comparison of computational complexity and memory usage between the conventional MMSE channel estimator and some embodiments of the disclosed MMS channel estimator using channel-dependent composite subcarriers and combined pilots. It can be seen why the disclosed technology can reduce both the computational complexity and the memory consumption. Using the conventional method (802), the cross-covariance matrix R_{H\tilde{H}} in EQU.10 is a long and fat matrix of size N×Nₚ, because its length corresponds to the number of all subcarriers N and its width corresponds to the total number of individual pilots Nₚ. The matrix (R_{HH}+(1/SNR)I)⁻¹ is square with a dimension that is determined by the total number of pilots Nₚ. The product of these two matrices is the pre-calculated MMSE matrix which has the same shape as R_{H\tilde{H}}. Multiple versions of the matrix corresponding to different CSI parameter combinations must be stored in the memory. The interpolator multiplies the LS channel estimation vector with this matrix in real time to produce the final channel estimation vector Ĥ.

By contrast, using the disclosed MMSE channel estimator (804), the cross-covariance matrix R_{H}_{_{cs}}_{\tilde{H}}_{_{cp}}, is both shorter and thinner than R_{H\tilde{H}} because the length of R_{H}_{_{cs}}_{\tilde{H}}_{_{cp}} is determined by the number of composite subcarriers N_{cs} and the width of R_{H}_{_{cs}}_{\tilde{H}}_{_{cp}} is determined by the number of combined pilots N_{cp}. For example, if one composite subcarrier consists of 4 subcarriers (N_{cs}=N/4) and one combined pilot consists of 2 pilots (N_{cp}=Nₚ/2), then the matrix R_{H}_{_{cs}}_{\tilde{H}}_{_{cp}} is 4 times shorter and 2 times thinner when compared with R_{H\tilde{H}}. Since the shape of the pre-calculated matrix is the same as that of R_{H}_{_{cs}}_{\tilde{H}}_{_{cp}}, an 8-times memory saving is achieved for this example. During the real-time interpolation, the pre-calculated N_{cs}×N_{cp} matrix is multiplied with the N_{cp}×1 vector of coarse channel estimates for combined pilots. The interpolator produces a vector of fine channel estimates for composite subcarriers which is used by the channel estimation demapper to generate final channel estimate vector for all subcarriers. The complexity of the demapper is much lower than that of MMSE channel estimation. For conventional method, the pre-calculated N×Nₚ matrix is multiplied with the Nₚ×1 vector, which results in roughly 8-times more computational complexity than the disclosed method.

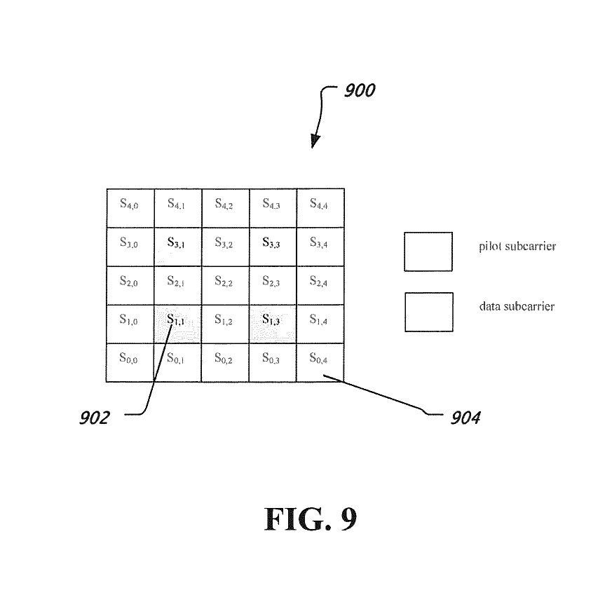

FIG. 9 illustrates how to utilize symmetry to further reduce memory required to store LUTs using an exemplary transmission grid 900 with 25 subcarriers, including 21 data subcarriers (904) and 4 pilot subcarriers (902).

It can be seen that the distances between S_{0,0} and the pilots [S_{1,1}, S_{1,3}, S_{3,1}, S_{3,3}] are the same as the distance between S_{4,4} and the pilots [S_{3,3}, S_{3,1}, S_{1,3}, S_{1,1}], the distance between S_{1,0} and the pilots [S_{1,1}, S_{1,3}, S_{3,1}, S_{3,3}] are the same as the distance between S_{3,4} and the pilots [S_{3,3}, S_{3,1}, S_{1,3}, S_{1,1}], and so on. Since the value of the filter coefficients ω_{k,l} is proportional to the distance between the location of the subcarrier for which channel gain is to be estimated and the locations of the pilots once the delay spread, Doppler frequency and SNR are set, the channel estimator only needs to store the 4 taps for either S_{0,0} or S_{4,4}. However, the order of the taps for S_{4,4} is reversed compared to the order of the 4 taps for S_{0,0}. This can be expressed as the following, given ω_{0,0}=[ω_{0,0}⁰, ω_{0,0}¹, ω_{0,0}², ω_{0,0}³]^{T}, ω_{4,4}=[(ω_{0,0}³)*, (ω_{0,0}²)*, (ω_{0,0}¹)*, (ω_{0,0}⁰)*]^{T}.

The same applies to the pairs S_{1,0} and S_{3,4}, S_{0,1} and S_{4,3}, and so on. Thus, by using the symmetry the number of rows of the pre-calculated interpolation matrix can be reduced at the cost of slightly increased complexity because the channel estimator needs to change the order of the taps depending on for which subcarrier the interpolation is being performed.

Even when a transmission pattern of pilot subcarriers is asymmetric, the above method can still be applied to the subcarriers that have the same distances to the set of pilots, thereby achieving savings in the amount of memory used to store the interpolation matrix coefficients.

In some embodiments, the number of subcarriers, and location and shape in the time frequency resource grid of each composite subcarrier is based on a corresponding estimated channel delay spread and a Doppler frequency value.

In some embodiments, the operation of interpolating the combined channel estimate comprises deriving channel estimates of each individual subcarrier from the channel estimate of the composite subcarrier which the individual subcarrier belongs to.

In some embodiments, e.g., as depicted in FIG. 7 (reference 714), the number of neighboring pilots grouped as a single combined pilot is based on at least one of a pilot subcarrier pattern, a channel delay spread and a Doppler frequency value, and a location of each combined pilot.

In some embodiments, a minimum mean square error (MMSE) channel filter coefficient generator apparatus includes a non-volatile memory and a processor executing instructions from memory for implementing a filter calculation. The method includes calculating, using a minimum least squares minimization criterion, values for a set of interpolation filter coefficients, wherein each interpolation filter can be used to calculate channel estimation values for individual subcarriers of an orthogonal frequency division multiplexing communication system from channel estimation values of groups of subcarriers.

In some embodiments, a channel estimation apparatus for use in a receiver of an OFDM signal includes an LS channel estimator for calculating LS channel estimates for individual pilots of the OFDM signal, a CSI estimator for estimating delay spread, Doppler frequency and Signal to Noise ratio of the OFDM signal, one or more LUTs containing pre-calculated sets of filter coefficients and information about associated composite subcarriers and combined pilots, a control unit which switches to an LUT based on the CSI estimates, and an interpolator using one of the LUTs with filter coefficients and information about associated composite subcarriers and combined pilots. In some embodiments, the apparatus may further include a pilot combiner to calculate coarse channel estimates for each combined pilot by combining the LS channel estimates of the individual pilots that belong to the combined pilot, and to calculate the location of the combined pilot as center of the gravity of the combined pilot. In some embodiments, the apparatus may further include a CSI estimator for estimating delay spread, Doppler frequency and SNR based on LS channel estimates of individual pilots. In some embodiments, the CSI estimator further comprises one or more low-pass exponential filters using different forgetting factors to filter out measurement noises in the delay spread, Doppler frequency and SNR measurements. In some embodiments, the CSI estimator includes a delay spread estimator, a Doppler frequency estimator and an SNR estimator. In some embodiments, the channel estimation apparatus the control unit is further configured to compare current delay spread, Doppler frequency and SNR estimates to their respective thresholds to decide if a different LUT should be used for interpolation. In some embodiments, the channel estimation apparatus further includes a channel interpolator connected to the LUTs that contain pre-calculated filter coefficients together with the information on the corresponding composite subcarriers and combined pilots.

The above-described LS channel estimator, the CSI estimator, including a delay spread estimator, a Doppler frequency estimator and an SNR estimator, the control unit, interpolator, LS channel estimator, signal rotator, combiner, a pilot combiner, CSI estimator, a delay spread estimator, a Doppler frequency estimator and an SNR estimator, channel interpolator and channel estimation demapper, can be implemented using a combination of hardware and software embodiments.

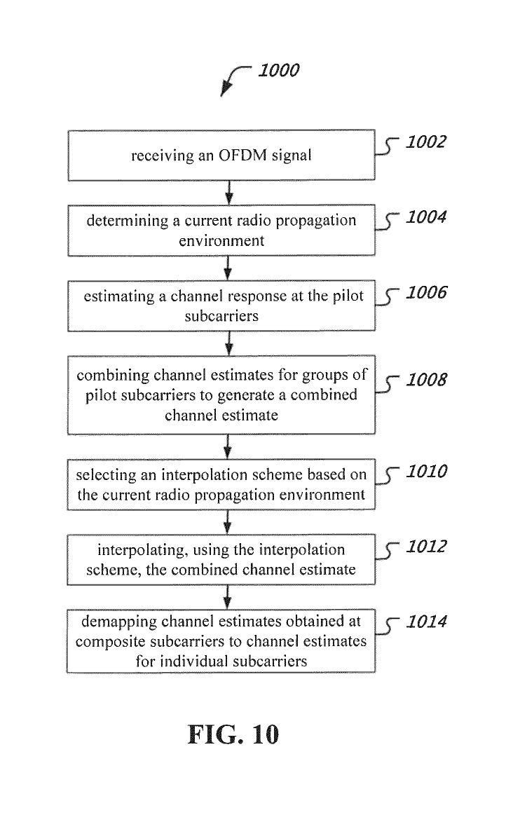

FIG. 10 shows an example of a method 1000 of estimating a channel in wireless communication.

The method 1000 includes, at 1002, receiving, via an optical receiver, an orthogonal frequency division multiplexing (OFDM) modulated signal in which data is modulated on data subcarriers and pilot signals are present on pilot subcarriers along a time-frequency resource grid.

The method 1000 includes, at 1004, determining, from the OFDM modulated signal, a current radio propagation environment. In some embodiments, an empirical radio propagation model is developed based on the OFDM modulated signal. The model then predicts the most likely behavior the link may exhibit for the current environment.

The method 1000 includes, at 1006, estimating a channel response at the pilot subcarriers. In some embodiments, a training sequence (or pilot sequence) can be used for the estimation, where a known signal is transmitted and the channel matrix is estimated using the combined knowledge of the transmitted and received signal.

The method 1000 includes, at 1008, combining channel estimates for groups of pilot subcarriers to generate a combined channel estimate. In some embodiments, training sequences from all pilot subcarriers are combined for the estimation of the channel matrix.

The method 1000 includes, at 1010, selecting an interpolation scheme based on the current radio propagation environment. In some embodiments, the pre-calculated interpolation matrices are stored in an LUT. The method switches to a more appropriate matrix depending on the measured CSI values.

The method 1000 includes, at 1012, interpolating, using the interpolation scheme, the combined channel estimate to obtain a composite subcarrier channel estimate in which channel estimates are obtained at composite subcarriers, wherein each composite subcarrier includes multiple subcarriers contiguous in time and/or frequency domain.

The method 1000 includes, at 1014, demapping, via a channel estimation demapper, channel estimates obtained at composite subcarriers to channel estimates for individual subcarriers.

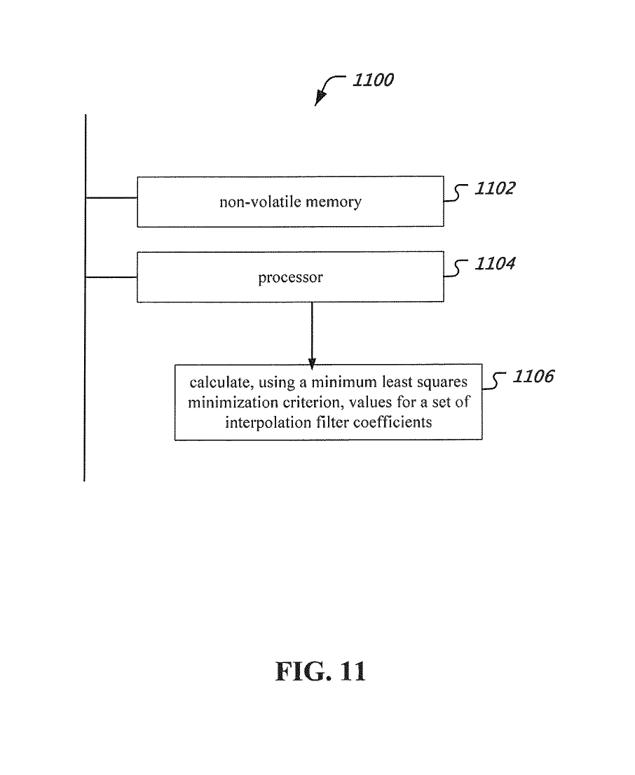

FIG. 11 shows an example block diagram of a minimum mean square error (MMSE) channel filter coefficient generator apparatus 1100. The apparatus 1100 includes non-volatile memory 1102 and a processor 1104 that executes instructions from the memory 1102 for implementing a filter calculation method comprising calculating at 1106, using a minimum least squares minimization criterion, values for a set of interpolation filter coefficients, wherein each interpolation filter can be used to calculate channel estimation values for individual subcarriers of an orthogonal frequency division multiplexing communication system from channel estimation values of groups of subcarriers.

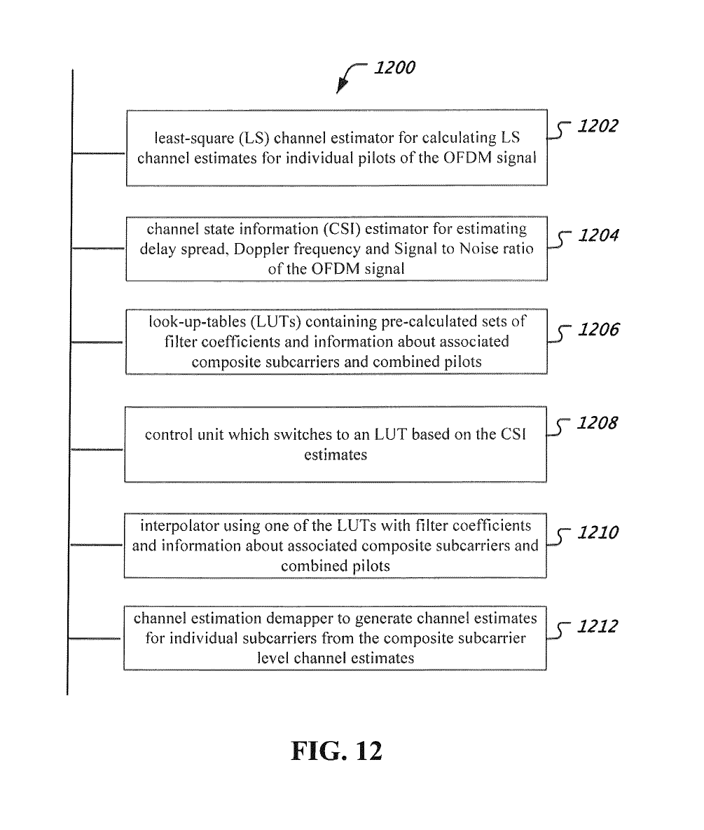

FIG. 12 shows an example block diagram of a channel estimation apparatus 1200 for use in a receiver of an orthogonal frequency division multiplexing (OFDM) signal.

The apparatus 1200 includes a least-square (LS) channel estimator 1202 for calculating LS channel estimates for individual pilots of the OFDM signal, a channel state information (CSI) estimator 1204 for estimating delay spread, Doppler frequency and Signal to Noise ratio of the OFDM signal, one or more look-up-tables (LUTs) 1206 containing pre-calculated sets of filter coefficients and information about associated composite subcarriers and combined pilots, a control unit 1208 which switches to an LUT based on the CSI estimates, an interpolator 1210 using one of the LUTs with filter coefficients and information about associated composite subcarriers and combined pilots, and a channel estimation demapper 1212 to generate channel estimates for individual subcarriers from the composite subcarrier level channel estimates.

Some embodiments disclosed in the present document can be narrated using the following clause-based description.

Clause 1. A method of reduced complexity MMSE channel estimator for 2D, 2×1D and 1D channel interpolation using channel-dependent composite subcarriers and combined pilots comprising: designing composite subcarriers and combined pilots based on pre-defined delay spread and maximum Doppler frequency combinations; wherein each combination corresponds to a significantly different mobile radio environment; pre-calculating MMSE filter coefficients using the designed composite subcarriers and combined pilots; storing the filter coefficients along with the information on the designed composite subcarriers and combined pilots in look-up-tables (LUTs) with one LUT corresponding to a specific combination of delay spread, Doppler frequency and SNR; estimating current delay spread, Doppler frequency and SNR, and switching to the most appropriate LUT based on the estimation results, the LUT consists of information for composite subcarriers, combined pilots and the filter coefficients; combining individual pilots to generate combined LS channel estimates using information for combined pilots in the LUT; interpolating between combined pilots to obtain composite subcarrier level channel estimates based on time-frequency correlation functions between the composite sub-carriers and combined pilots.

Clause 2. The method of clause 1 wherein designing composite subcarriers comprises determining (a) the number of subcarriers N_{cs}, (b) the shape and (c) location (k_{cs},l_{cs}) of each composite subcarrier based on the delay spread and Doppler frequency combination.

Clause 3. The method of clause 1 wherein designing combined pilots comprises determining which of the N_{cp} neighboring pilots can be grouped as a single combined pilot based on pilot pattern, delay spread and Doppler frequency, and calculating the location (k_{cp},l_{cp}) of each combined pilot.

Clause 4. The method of clause 1 wherein using composite subcarriers and combined pilots reduces the computational complexity and memory usage by an order of (N−N_{cs})(Nₚ−N_{cp}).

Clause 5. The method of clause 4 wherein reducing memory usage further comprises utilizing symmetry of composite subcarriers with respect to combined pilots. The same set of filter taps can be used for multiple composite subcarriers that have the same distances to the set of combined pilots with proper tap reordering depending on the composite subcarrier being considered.

Clause 6. The method of clause 1 wherein MMSE channel interpolation comprises first calculating least-square (LS) channel estimates for individual pilots, and then combining the LS estimates belonging to each combined pilot to obtain coarse channel estimate of the combined pilot.

Clause 7. The method of clause 1 wherein MMSE channel interpolation comprises interpolating the coarse channel estimates for combined pilots to obtain composite subcarrier level channel estimates and then deriving channel estimate of each individual subcarrier from the channel estimate of the composite subcarrier which the individual subcarrier belongs to.

Clause 8. The method of clause 6 wherein generating least-square channel estimate for a combined pilot comprises averaging or interpolating the LS channel estimates of the individual pilots that are associated with the combined pilot.

Clause 9. The method of clause 3 wherein the individual pilots of a combined pilot can be non-contiguous and a combined pilot can overlap with a composite subcarrier.

Clause 10. The method of clause 6 wherein, if the individual pilots within a combined pilot are not contiguous, a preliminary channel estimate of a non-pilot subcarrier within the boarder of the combined pilot is calculated by linear interpolation of two adjacent pilots.

Clause 11. The method of clause 7 wherein deriving channel estimate of an individual subcarrier comprises copying the channel estimate of the composite subcarrier which the subcarrier belongs to.

Clause 12. The method of clause 1 wherein MMSE channel estimation further comprises measuring delay spread, Doppler frequency and SNR using LS channel estimates of individual pilots as inputs.

Clause 13. The method of clause 12 wherein estimating delay spread, Doppler frequency and SNR comprises low-pass filtering delay spread, Doppler frequency and SNR measurements to generate final estimates for these channel state information (CSI) parameters.

Clause 14. The method of clause 1 wherein MMSE channel estimation further comprises comparing delay spread, Doppler frequency and SNR estimates to their respective thresholds, and switching to a different LUT if at least one of the CSI estimates exceeds a threshold.

Clause 15. An MMSE channel filter coefficient generator for pre-calculating MMSE filter coefficients for different sets of CSI design values and for different types of MMSE channel interpolators, including 2D, 1D and 2×1D MMSE channel interpolators.

Clause 16. An MMSE channel estimation circuit in an OFDM/MIMO-OFDM receiver comprising (1) a least-square (LS) channel estimator for calculating LS channel estimates for individual pilots, (2) a channel state information (CSI) estimator for estimating delay spread, Doppler frequency and SNR, (3) look-up-tables (LUTs) containing pre-calculated sets of MMSE filter coefficients and information about associated composite subcarriers and combined pilots, (4) a control unit which switches to the most appropriate LUT based on the CSI estimates, (5) a pilot combiner for combining LS channel estimates for individual pilots to form coarse channel estimates for combined pilots, (6) an MMSE interpolator using one of the LUTs with MMSE filter coefficients and information about associated composite subcarriers and combined pilots, and (7) channel estimation demapper for deriving subcarrier level channel estimates from composite subcarrier level channel estimates.

Clause 17. An MMSE channel estimation circuit of clause 16 further comprises an LS channel estimator to calculate LS channel estimates of individual pilots.

Clause 18. The LS channel estimator of clause 17 further comprises a signal rotator for back-rotating received pilot signals to generate LS channel estimates.

Clause 19. An MMSE channel estimation circuit of clause 16 further comprises a pilot combiner to calculate coarse channel estimates for each combined pilot by combining the LS channel estimates of the individual pilots that belong to the combined pilot, and to calculate the location of the combined pilot as center of the gravity of the combined pilot.

Clause 20. An MMSE channel estimation circuit of clause 16 further comprises a CSI estimator for estimating delay spread, Doppler frequency and SNR based on LS channel estimates of individual pilots.

Clause 21. A CSI Estimator of clause 20 further comprises low-pass exponential filters using different forgetting factors to filter out measurement noises in the delay spread, Doppler frequency and SNR measurements.

Clause 22. A CSI estimator of clause 20 further comprises a delay spread estimator, a Doppler frequency estimator and an SNR estimator.

Clause 23. An MMSE channel estimation circuit of clause 16 further comprises a control unit configured to compare current delay spread, Doppler frequency and SNR estimates to their respective thresholds to decide if a different LUT should be used for interpolation.

Clause 24. An MMSE channel estimation circuit of clause 16 further comprises a channel interpolator connected to the LUTs that contain pre-calculated filter coefficients together with the information on the corresponding composite subcarriers and combined pilots.

Clause 25. A method of 2D MMSE channel estimation for LTE/LTE-Advanced MIMO transmission based on UE-RS type of pilot signals wherein the two consecutive pilots in time domain of each PRB is combined to form a combined pilot, reducing the number of pilots to be interpolated from 12 to 6.

Clause 26. A method of 2D MMSE channel estimation to improve the interference covariance estimation accuracy for UE-RS pilots which in turn improves the performance of interference rejection combining receiver performance.

It will be appreciated that techniques for reducing computational complexity of channel estimation have been disclosed. It will further be appreciated that techniques for reducing channel estimation memory storage requirement of a wireless channel receiver are disclosed.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is what is described and illustrated, including:

1. A method of estimating a channel in wireless communication, including:
receiving an orthogonal frequency division multiplexing (OFDM) modulated signal in which data is modulated on data subcarriers and pilot signals are present on pilot subcarriers along a time-frequency resource grid;
determining, from the OFDM modulated signal, a current radio propagation environment;
estimating a channel response at the pilot subcarriers;
combining channel estimates for groups of pilot subcarriers to generate a combined channel estimate;
selecting an interpolation scheme based on the current radio propagation environment;
interpolating, using the interpolation scheme, the combined channel estimate to obtain a composite subcarrier channel estimate in which channel estimates are obtained at composite subcarriers, wherein each composite subcarrier includes multiple subcarriers contiguous in time and/or frequency domain; and
demapping channel estimates obtained at composite subcarriers to channel estimates for individual subcarriers.

2. The method of claim 1 wherein a number of subcarriers, a location of the and a shape in the time frequency resource grid of each composite subcarrier is based on a corresponding channel delay spread and a Doppler frequency value.

3. The method of claim 1 wherein a number of neighboring pilots grouped as a single combined pilot is based on at least one of a pilot subcarrier pattern, a channel delay spread and a Doppler frequency value.

4. The method of claim 1, wherein the selecting the interpolation scheme comprises selecting an interpolation filter from a look up table (LUT).

5. The method of claim 4 wherein a same set of interpolation filter taps are used for multiple composite subcarriers.

6. The method of claim 1 wherein the estimating the channel response at the pilot subcarriers includes calculating least-square (LS) channel estimates for individual pilots, and wherein the combining channel estimates includes combining the LS channel estimates belonging to each combined pilot.

7. The method of claim 1 wherein the interpolating the combined channel estimate comprises multiplying the interpolation filter with the combined channel estimates to generate channel estimates for composite subcarriers, and demapping composite subcarrier level channel estimates comprises deriving channel estimates of each individual subcarrier from the channel estimate of the composite subcarrier which the individual subcarrier belongs to.

8. The method of claim 6 wherein the calculating the LS channel estimate for a combined pilot comprises averaging or interpolating the LS channel estimates of the individual pilots that are associated with the combined pilot.

9. The method of claim 3 wherein the individual pilots of a combined pilot can be non-contiguous and a combined pilot can overlap with a composite subcarrier.

10. The method of claim 6 wherein, if the individual pilots within a combined pilot are not contiguous, a preliminary channel estimate of a non-pilot subcarrier within the border of the combined pilot is calculated by linear interpolation of two adjacent pilots.

11. The method of claim 7 wherein deriving channel estimate of an individual subcarrier comprises copying the channel estimate of the composite subcarrier to which the subcarrier belongs.

12. The method of claim 1 wherein the interpolating includes interpolating using an interpolation filter whose coefficients are calculated using an optimization algorithm that minimizes mean square error of calculation.

13. The method of claim 12 wherein estimating delay spread, Doppler frequency and SNR comprises low-pass filtering delay spread, Doppler frequency and SNR measurements to generate final estimates.

14. The method of claim 1 further including comparing delay spread, Doppler frequency and SNR estimates to their respective thresholds, and switching to a different LUT if at least one of them exceeds a threshold.

15. A minimum mean square error (MMSE) channel filter coefficient generator apparatus, comprising:
a non-volatile memory; and
a processor executing instructions from memory for implementing a filter calculation method comprising:
calculating, using a minimum least squares minimization criterion, values for a set of interpolation filter coefficients, wherein each interpolation filter can be used to calculate channel estimation values for individual subcarriers of an orthogonal frequency division multiplexing communication system from channel estimation values of groups of subcarriers.

16. The apparatus of claim 15, wherein the interpolation filter is one of a two-dimensional filter, a one-dimensional filter and a separable two dimensional filter.

17. A channel estimation apparatus for use in a receiver of an orthogonal frequency division multiplexing (OFDM) signal; comprising:
a least-square (LS) channel estimator for calculating LS channel estimates for individual pilots of the OFDM signal;
a channel state information (CSI) estimator for estimating delay spread, Doppler frequency and Signal to Noise ratio of the OFDM signal,
one or more look-up-tables (LUTs) containing pre-calculated sets of filter coefficients and information about associated composite subcarriers and combined pilots,
a control unit which switches to an LUT based on the CSI estimates,
an interpolator using one of the LUTs with filter coefficients and information about associated composite subcarriers and combined pilots, and
a channel estimation demapper to generate channel estimates for individual subcarriers from the composite subcarrier level channel estimates.

18. The channel estimation apparatus of claim 17 further including an least-squares (LS) channel estimator to calculate LS channel estimates of individual pilots.

19. The channel estimation apparatus of claim 18, wherein the LS channel estimator further comprises:
a signal rotator for back-rotating received pilot signals to generate LS channel estimates.

20. The channel estimation apparatus of claim 17 further comprises a pilot combiner to calculate coarse channel estimates for each combined pilot by combining the LS channel estimates of the individual pilots that belong to the combined pilot, and to calculate the location of the combined pilot as center of the gravity of the combined pilot.

21. The channel estimation apparatus of claim 17 further comprises a CSI estimator for estimating delay spread, Doppler frequency and SNR based on LS channel estimates of individual pilots.

22. The channel estimation apparatus of claim 17, wherein the CSI Estimator further comprises one or more low-pass exponential filters using different forgetting factors to filter out measurement noises in the delay spread, Doppler frequency and SNR measurements.

23. The channel estimation apparatus of claim 17, wherein the CSI Estimator further comprises a delay spread estimator, a Doppler frequency estimator and an SNR estimator.

24. The channel estimation apparatus of claim 17 wherein:
the control unit is further configured to compare current delay spread, Doppler frequency and SNR estimates to their respective thresholds to decide if a different LUT should be used for interpolation.

25. The channel estimation apparatus of claim 17 further including:
a channel interpolator connected to the LUTs that contain pre-calculated filter coefficients together with the information on the corresponding composite subcarriers and combined pilots.
